(19) United States
(12) Patent Application Publication
(10) Pub. No.: US 2005/0123042 A1
(43) Pub. Date: Jun. 9, 2005

(54) Moving picture streaming file, method and system for moving picture streaming service of mobile communication terminal

(75) Inventor: Seong-Jun Park, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/002,685

(22) Filed: Dec. 3, 2004

(30) Foreign Application Priority Data
Dec. 5, 2003 (KR) 88218/2003

(51) Int. Cl. H04B 1/66

(52) U.S. Cl. 375/240.12

(57) ABSTRACT

A moving picture streaming file, method and system for a moving picture streaming service of a mobile communication terminal. The streaming file is generated by adding audio payload data to an MJPEG moving picture file, and adding payload headers for controlling streaming of each payload data. When the mobile communication terminal requests the streaming service, a server provides the previously-generated wireless moving picture streaming file to the terminal. The terminal then plays the payload data using payload header information of the streaming file, and controls transmission of the payload data including a plurality of segments using segment headers.

### CROSS-REFERENCE TO A RELATED APPLICATION

This application claims priority to Korean patent application No. 88218/2003 filed on Dec. 5, 2003, the entire contents of which is hereby incorporated in its entirety.

### BACKGROUND OF THE INVENTION

1. Field of the Invention

The present invention relates to a method and system for providing a moving picture streaming service through a mobile communication terminal, and a corresponding moving picture streaming file format for the streaming service.

2. Background of the Related Art

In general streaming is a multimedia data transmission method which reads, transmits and plays data on an Internet in real time. The streaming technology allows the user to watch or listen to a large capacity of video or audio data on the Internet in real time without downloading the data to a PC (Personal Computer), for example.

The above technology is roughly divided into a moving picture compression algorithm and a network protocol. Moving picture compression algorithms include Moving Picture Experts Group (MPEG) and H.26x, and network protocols include a Real time Transport Protocol (RTP) and a Real Time Control Protocol (RTCP).

MPEG and H.26x a5e hybrid compression methods including motion compensation compression and DCT loss compensation. The motion compensation compression estimates a motion using a difference between a previous frame and a current frame, and compensates for the estimated motion. The DCT loss compression separates an image into a low frequency component having visually important information and a high frequency component having visually less important information, and applies a loss to the low frequency component. RTP is a protocol for transmitting multimedia data and has a structure for discerning a receive sequence number from a payload. The RTCP monitors and manages RTP data transmission.

The moving picture compression standard is characterized by basically using the DCT loss compression and the motion compensation compression, and also using a quantized matrix algorithm and Huffman/Runlength compression algorithm. The quantized matrix algorithm improves compression efficiency by quantizing a DCTed DCT coefficient using the assumption the image is mostly concentrated on the low frequency component. The Huffman/Runlength compression algorithm, which transforms a fixed length code into a variable length code, makes an average code length smaller than a fixed length of an original symbol by allocating a short code to a frequently-generated symbol and a long code to a rarely-generated symbol.

The moving picture compression algorithms such as MPEG and H.26x and the network protocols such as RTP and RTCP are generally used in wire networks. On the other hand, as the mobile communication service becomes diversified, there are increasing demands for a wireless moving picture streaming service using a mobile communication terminal. However, the above-noted moving picture compression algorithms and network protocols cannot be applied to a mobile communication network environment due to many restrictions.

That is, the mobile communication network environment has a number of restrictions not including within a wire network, such as multi-channel fading, handoff and power attenuation, etc. A mobile communication terminal also general has a smaller central processing unit, a smaller memory, and a lower memory access speed especially when compared to a stand-alone PC.

Thus, the general moving picture compression algorithm and network protocol do not properly operate within a mobile communication terminal. Further, when the moving picture streaming service of the mobile communication terminal uses the general moving picture compression algorithm and network protocol, images are often interrupted due to the aforementioned restrictions of the mobile communication network. As a result, the quality of the service is considerably reduced. In addition, while the moving pictures are transmitted on the wireless network using the general moving picture compression algorithm and network protocol, if deadlock occurs, a retransmission-requested frame and a reference frame must be transmitted together according to characteristics of the motion compensation algorithm. It is thus difficult to provide the streaming service to a mobile terminal using the general methods, Therefore, a high specification, high-priced mobile communication terminal would be required to solve the above problem.

### SUMMARY OF THE INVENTION

Accordingly, one object of the present invention is to at least address the above-noted and other problems.

Another object of the present invention is to store information for identifying the moving picture streaming file in a header of the strong file, and storing payload data played in the moving picture streaming service and payload headers for controlling and managing streaming of the payload data in a payload of the moving picture streaming file.

Additional advantages, objects, and features of the invention will be set forth in part in the description which follows and in part will become apparent to those having ordinary skill the art upon examination of the follow or may be earned from practice of the invention. The objects and advantages of the invention may be realized and attained as particularly pointed out in the appended claims.

### BRIEF DESCRIPTION OP THE DRAWINGS

The invention will be described in detail with reference to the following drawings in which lice reference numerals refer to like elements wherein:

FIG. 1 is a view illustrating a format of a wireless moving picture streaming file according to the present invention;

FIG. 2 is a view illustrating a format of a payload according to the present invention;

FIG. 3 is a view illustrating a format of a payload data according to the present invention;

FIG. 4 is a view illustrating an MSW system according to the present invention; and

FIG. 5 is a view illustrating a software structure of a mobile communication terminal according to the present invention.

### BEST MODE OF THE INVENTION

In general, Motion Joint Photographic Experts Group (MJPEG) applies JPEG, which is a still image compression method, to moving picture compression. That is, each frame in MJPEG is compressed according to JPEG. JPEG, which is the international standard for continuous tone still image compression defined by the Committee Consultative International Telegraphy and Telephony (CCITT) and the International Organization for Standardization (ISO), specifics requirements for compressing almost all two-dimensional still images such as gray level images or color images except binary images.

MJPEG compresses each frame as a single tame recess of preceding and succeeding frames, and also compresses moving picture play information, thereby attaining a higher compression ratio than the MPEG. In addition, MJPEG can control a quality of the image by adjusting the compression ratio during compression, and perform rapid compression because of a smaller amount of required calculations.

According to the present invention, a moving picture streaming file is compressed not by the motion compensation compression method, but by MJPEG, and moving pictures are rapidly and reliably transmitted through a User Datagram Protocol (UDP), by adding an audio payload to the moving picture file based on MJPEG, forming payload headers in each payload data for controlling and managing streaming of the payload data, and dividing each of the payload data into a plurality of segments for transmission control.

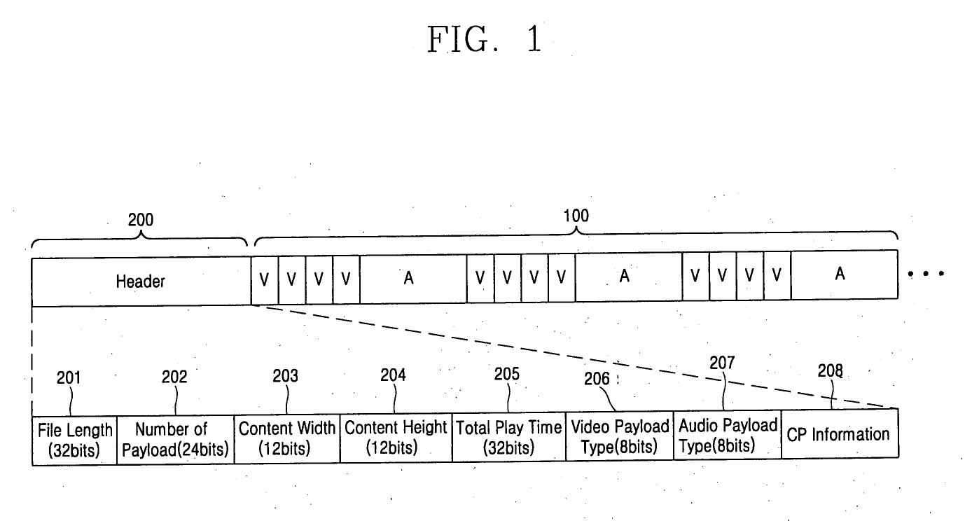

In more detail, FIG. 1 illustrates a format of a wireless moving picture streaming file according to the present invention. As shown, the streaming file is formed by adding audio data to a payload of an MPEG moving picture file. That is, the streaming file includes a payload 100 having a plurality of video frames V and audio data A that are to be streamed. Also shown is a file header 200 identifying the steaming file.

As shown, the file header 200 includes, for example.
1) file length (32 bits) 201,
2) number of payload (24 bits) 202,
3) content width (12 bits) 203,
4) content height (12 bits) 204,
5) total play time (32 bits) 205,
6) video payload type (8 bits) 206,
7) audio payload type (8 bits) 207, and
8) Contents Provider (CP) information (field length is variable) 208.

In the payload 100, one vide payload data V implies one video frame, and one audio payload data A implies a predetermined length of audio data As shown, the payload 100 is filled by adding the audio data A played for a first time to a plurality of video frames V played for the first time, and adding the audio data A played for a second time to a plurality of video frames V played for the second time.

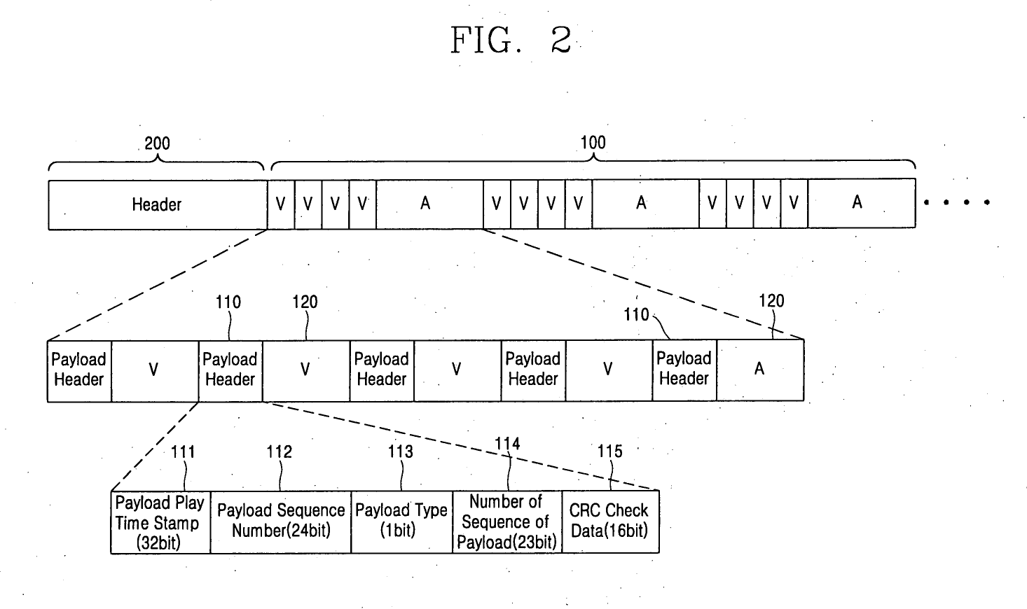

As illustrated in FIG. 2, the payload 100 includes payload headers 110 corresponding to each video frame and audio data 120. As shown, each payload header 110 includes, for example:
1) payload play time stamp (32 bits) 111,
2) payload sequence number (24 bits) 112,
3) payload type (1 bit) 113,
4) number of segments of payload (23 bits) 114, and
5) Cyclic Redundancy Check (CRC) data (16 bits) 115.

The payload play time stamp 111 is used with the frame play time stamp to synchronize the video frames 120 with the audio data 120.

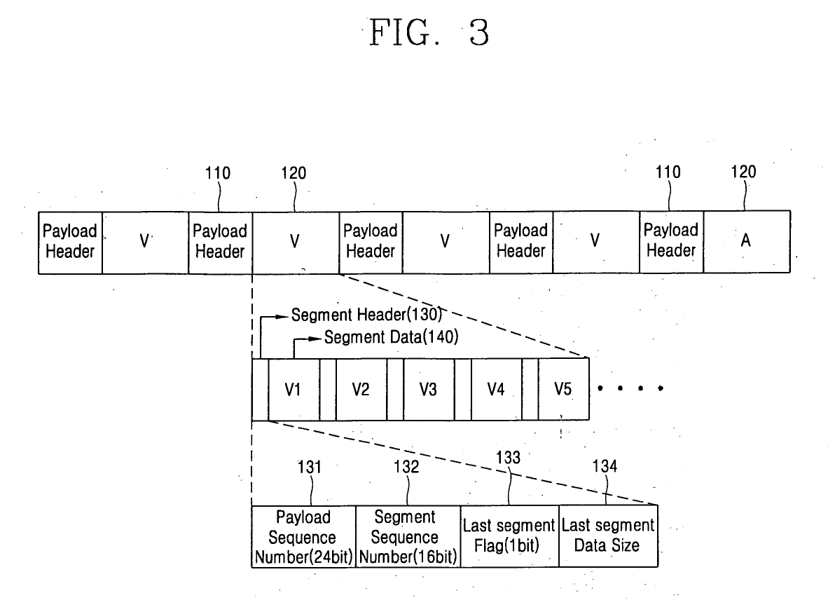

As shown in FIG. 3, each video frame and audio data 120 are divided into a plurality of segments. Further, be segments include segment headers 130 and segment data 140. The size of each segment is fixed, for example, 512 bytes. According to the present invention, each video frame and audio data of the streaming file transmitted through the UDP can be transmitted under control, by dividing each video frame and audio data into the plurality of segments, and controlling the transmission of the segments using the segment headers 130.

As shown in FIG. 3, each segment header 130 includes, for example:
1) payload sequence number (24 bits) 131,
2) segment sequence number (16 bits) 132,
3) last segment flag (1 bit) 133, and
4) last segment data size (7 bits) 134.

When the streaming file is transmitted through the UDP, the transmission order of the segments may be changed based on the characteristics of the UDP. Therefore, the payload sequence number 131 and the segment sequence number 132 are transmitted with the segments. In addition, a value of ‘0’, for example in the last segment flag means the current segment is not the last segment of the payload, and a value “1” means the current segment is the last segment of the payload. Further, when the current segment is not the last segment, the last segment data size 134 is meaningless, and thus this field is filled with ‘0’.

Thus, the present invention is an improvement over MJPEG. That is, the present invention adds audio payload data, adds payload headers to each payload data, and divides each payload data into a plurality of segments for transmission.

Hereinafter, a system according to the present invention for providing a wireless moving picture streaming service to a mobile communication terminal using a wireless moving picture streaming file will be defined as a Multimedia Streaming for Wireless (MSW) system. Further, an encoder for encoding the wireless moving picture streaming file (or MSW file) will be referred to as an MSW encoder, and a decoder for decoding the will now be referred to as an MSW decoder.

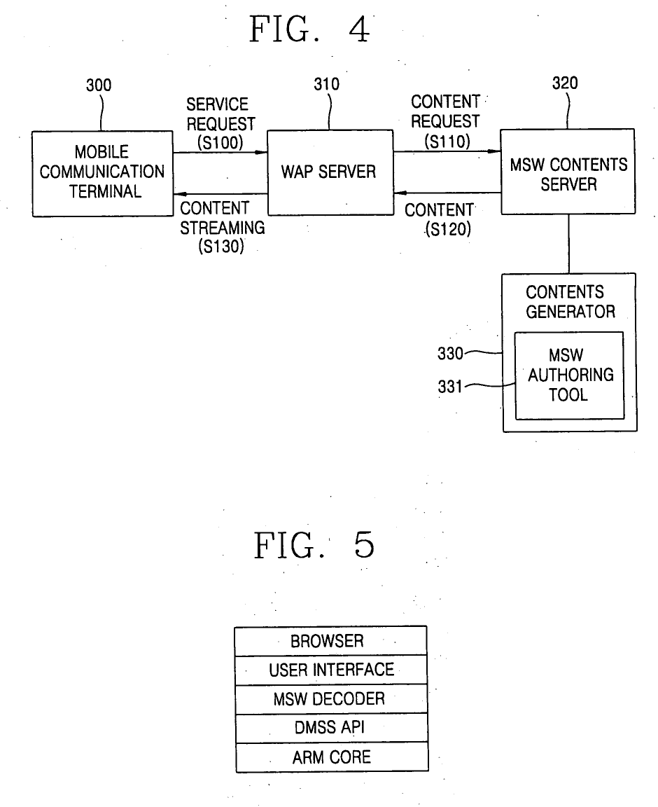

Next FIG. 4 illustrates an example of an MSW system according to the present invention. As shown, the MSW system includes a mobile communication terminal 300 for requesting and receiving a wireless moving picture streaming service, a Wireless Application Protocol (WAP) server 310 for performing content streaming for the streaming service through wireless access to the terminal 300, an MSW contents sever 320 for providing the content to the WAP server 310 according to a request signal from the WAP server 310, and a contents generator 330 for generating the content by MSW encoding and storing the content in the MSW contents server 320.

As illustrated in FIG. 5, the terminal 300 has, for example, a software structure of an Advanced RISC Machines (ARM) core for performing CPU functions, a Dual Mode Subscriber Software (DMSS) Application Program Interface (API) for supporting an MSW Codec program, an MSW decoder for decoding an MJPEG moving picture streaming file, a user interface for interfacing with the use, and a browser.

The contents generator 330 corresponds to a PC 330, for example, and the PC 330 generates MSW content using an MSW authoring tool 331 for encoding a picture streaming file by MSW encoding.

The operation of the MSW system according to the present invention will now be described.

The contents generator 330 generates the MSW content using the MSW authoring tool 331. That is, the PC 330 generates the wireless moving picture streaming file using the MSW encoder of the MSW tool 331. In mote detail, the PC 330 divides the video frames and the audio data for the streaming service into a segment data size, stores the divided frames and data, adds the segment headers that are used to control the transmission of the segment data, stores the plurality of segmented data and headers corresponding to the video frames in the video payload data fields, generates the payload headers for the video payload data, stores the plurality of segmented data and headers corresponding to the audio data in the audio payload data fields, and generates the payload headers for the audio payload data. The PC 330 also generates the payload using the payload headers and the payload data for the video frames and audio data, and generates the file header for the payload, thereby generating the wireless moving picture streaming file for the MSW streaming service. Further, the PC 330 stores the MSW content including the MSW file in the MSW contents server 320.

Then, when the user requests the wireless moving picture streaming service through the terminal 300 (S100), the WAP server 310 requests the corresponding MSW content from the MSW contents server 320 (S110). Next, the MSW contents server 320 provides the MSW content to the WAP server 310 (S120) and the WAP server 310 transmits the MSW file to the terminal 300 (S130). Here, MSW file is transmitted through the UDP between the WAP server 310 and the terminal 300.

The MSW decoder of the terminal 300 recognizes the content streaming for the MSW service using the file header information of the MSW file, and plays the payload data using the payload header information of the file. When receiving the payload data through the UDP, the terminal 300 controls transmission of the segment data of the payload data using the segment header information of the payload data, so the payload data divided into the plurality of segment data can be aligned and played in the proper transmission order.

Accordingly, even though the MSW file is transmitted through the UDP via a wireless service, the MSW file can be rapidly and reliably transmitted by controlling the transmission using the segment headers of the payload data

As discussed above, according to the present invention, the MSW file includes the file header for identifying the MSW file, the payload data divided into segment data and segment headers for transmission control, and the payload headers for controlling and managing the streaming of the payload data. Therefore, the MSW file can be rapidly and reliably transmitted through the UDP, and the moving pictures can be compressed and played according to MJPEG.

In addition, because the motion compensation compression generally used for moving picture compression is not used in the present invention, when a deadlock due to fading for example, occurs, the deadlock can be easily overcome by retransmitting the moving picture frames for the current image, without referring to the preceding or succeeding image, namely, the reference image. Further, the structure of the decoder of the mobile communication terminal is also simplified by omitting a frame memory for storing reference images, and for receiving and playing the independent image. Moreover, the RAM usage of the terminal 300 is reduced by omitting a Group Of Picture (GOP) unit file access by motion compensation.

Further, the MSW service is provided to the terminal 300 using an expanded MJPEG moving picture file according to the present invention, which decreases the ROM usage of the terminal 300.

In addition, because the MSW file does not have information for the many-to-many multicast environment such as a synchronization sender ID, the MSW system according to the present invention is optimized for a one-to-many broadcast environment, and for attaining a high transmission speed.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A wireless moving picture streaming file for a moving picture steaming service of a mobile communication terminal, comprising:
a file header for identifying the streaming file; and
a payload including video payload data and audio payload data compressed according to MJPEG (Motion Joint Photographic Experts Group), and payload headers corresponding to each video and audio payload data for controlling a streaming of the payload.

2. The file of claim 1, wherein the file header comprises:
a total file length of the streaming file;
a total number of the payloads;
a width of content for the streaming service;
a height of the content;
a total play time of the content;
an encoding type of video frames of the content;
an encoding type of audio data of the content; and
information of a contents provider providing the content.

3. The file of claim 1, wherein each payload header comprises:
a play time stamp of a current payload;
a sequence number of the current payload;
a type of the current payload;
a total number of segments of the current payload; and
a cyclic redundancy check data for checking an integrity of the current payload.

4. The file of claim 1, wherein the video and audio payload data are divided into a plurality of segments for transmission control, and each segment includes a segment header and segment data.

5. The file of claim 4, wherein transmission of the segments is controlled using the segment headers.

6. The file of claim 5, wherein each segment header comprises:
a sequence number of the payload to which a current segment belongs;
a sequence number of the current segment;
a flag data for checking whether the current segment is a last segment of the payload; and
a data size of the last segment.

7. The file of claim 1, wherein the payload comprises a plurality of video frames played for a fist period and a predetermined length of audio data synchronized with the plurality of video frames, and wherein a total play time of the wireless moving picture streaming file is divided into predetermined periods and the first period is one of the predetermined periods.

8. A system for providing a moving picture streaming service of a mobile communication terminal, comprising:
a streaming contents generator configured to generate content by wireless moving picture streaming-encoding video frames and audio data according to MJPEG (Motion Joint Photographic Experts Group);
a contents server configured to store and manage the generated content; and
a wireless application protocol server configured to search the content requested by the terminal in the contents server, and to stream the searched content to the terminal.

9. The system of claim 8, wherein the terminal comprises a decoder configured to picture stream-decode the content according to MJPEG, and a display configured to display the stream-decoded content.

10. The system of claim 8, wherein the content comprises a wireless moving picture streaming file, and
wherein the content generator adds audio payload data to an MJPEG moving picture file to form a payload, and adds a payload header to the payload for controlling and managing streaming of the payload data.

11. The system of claim 8, wherein the contents generator divides the payload data into a plurality of segments for transmission control, and each segment includes a segment header and segment data.

12. The system of clan 8, wherein the content is transmitted through a user datagram protocol between the terminal and the wireless application protocol server.

13. The system of claim 8, wherein the contents generator divides the video frames and audio data compressed according to MJPEG into a plurality of segments, generates a segment header for each segment for controlling transmission of the segment, generates a video payload header for each video frame for controlling streaming of the video frames, generates an audio payload header for each audio data for controlling streaming of the audio data, and generates a file header for identifying the content for the streaming.

14. The system of claim 13, wherein the terminal recognizes content streaming for the streaming service using the file header of the content, plays the payload data using information in the payload header, and controls transmission of the segment data of the payload data using information of the segment header of the payload data.

15. A method for providing a moving picture streaming service of a mobile communication terminal, comprising:
requesting a wireless moving picture streaming service from a server;
receiving a moving picture streaming file from the server through a user datagram protocol;
recognizing the moving picture streaming file using a file header of the steaming file; and
playing video frames and audio data of payload data of the streaming file using payload headers of the moving picture steaming file.

16. The method of claim 15, further comprising
segmenting the payload data into a plurality of segments; and
controlling a transmission of segmented data of the payload data between the terminal and the server using segment headers of the payload data.

17. The method of claim 15, further comprising:
dividing the video frames and the audio data into a plurality of segments before transmission to the terminal;
adding segment headers for transmission control to each segment;
adding video payload headers for controlling streaming to each video frame, adding audio payload headers for controlling streaming to each audio data; and
adding a file header to the assembled video and audio data for identifying the content for the wireless moving picture streaming service.

18. The method of claim 17, when the file header comprises:
a total file length of the streaming file;
a total number of the payloads;
a width of content for the streaming service;
a height of the content;
a total play time of the content;
an encoding type of video frames of the content;
an encoding type of audio data of the content; and
information of a contents provider providing the content.

19. The method of claim 17, wherein each video and audio payload header comprises:
a play time stamp of the current payload;
a sequence number of the current payload;
a type of the current payload;
a total number of segments of the current payload; and
a cyclic redundancy check data for checking integrity of the current payload.

20. The method of claim 17, wherein each segment header comprises:
a sequence number of the payload to a current segment belongs;
a sequence number of the current segment;
a flag data for checking whether the current segment is the last segment of the payload; and
size information of data of the last segment.

21. The method of claim 15, wherein the video frames are independent frames encoded without reference frames.

22. A moving picture streaming method, comprising:
compressing each video frame of a requested moving picture streaming file without consideration of a previous frame or next frame;
segmenting the compressed video frames and audio data associated with the video frames into a plurality of video and audio segments; and
adding a video header to each video segment and an audio headset to each audio segment,
wherein the video and audio headers each include a sequence number of a payload a corresponding segment belongs to and a segment sequence number identifying sequence number of the segment.

23. The method of claim 22, wherein compressing each frame compresses each frame according to MJPEG (Motion Joint Photographic Experts Group).

24. The method of claim 22, fixer comprising:
assembling the segmented video and audio segments into a payload;
adding a file header to the payload; and
tansmitting the file header and payload to a mobile terminal using a user datagram protocol.

25. The method of claim 22, further comprising controlling a transmission of the segmented data using the respective headers of the segmented data.

26. The method of claim 24, wherein the file header comprises:
a total file length of the streaming file;
a total number of the payloads;
a width of content for the streaming service;
a height of the content;
a total play time of the content;
an encoding type of video frames of the content;
on encoding type of audio data of the content; and information of a contents provider providing the content.

27. The method of claim 22, wherein each segment header further comprises:
a flag data for checking whether the current segment is the last segment of the payload; and
size information of data of the last segment.
